(19) United States
(12) Patent Application Publication
(10) Pub. No.: US 2002/0198783 A1
(43) Pub. Date: Dec. 26, 2002

(54) Business method for credit card email alerts

(75) Inventors: Cary Lee Bates, Rochester, MN (US); Mahdad Majd, Rochester, MN (US); John Matthew Santosuosso, Rochester, MN (US)

Correspondence Address: Gero G. McClellan, Thomason, Moser & Patterson, L.L.P., Suite 1500, 3040 Post Oak Boulevard, Houston, TX, 77056-6582, US

(73) Assignee: International Business Machines Corporation, Armonk, NY (US)

(21) Appl. No.: 09/887,623

(22) Filed: Jun. 22, 2001

(51) Int. Cl. G06F 17/60

(52) U.S. Cl. 705/20

(57) ABSTRACT

Embodiments of the present invention generally provide method and apparatus for tracking price reduction of a purchased item and notifying a customer of the price reduction. One embodiment provides a method for tracking a price reduction for an item purchased by a customer, comprising: receiving, by a central computer system, transaction data from a store computer system, the transaction data including an item identification number and an item purchase price; comparing an item sale price to the item purchase price; and if the item purchase price is higher than the item sale price, creating a notification file for the customer. The notification file may comprise an electronic mail and include one or more information selected from item sale price, item purchase price, purchase date, and store name.

### RELATED PATENT APPLICATIONS

This patent application is related to the following patent application which is filed concurrently herewith and is hereby incorporated by reference: United States Patent Application ROC920010071 entitled “ENCOURAGING HOUSE CARD USE THROUGH PRICE GUARANTEES”, having Ser. No. ______.

### BACKGROUND OF THE INVENTION

1. Field of the Invention

he present invention generally relates to a computer implemented method for tracking price reduction of a purchased item and notifying a customer of the price reduction.

2. Description of the Related Art

Many stores have price guarantee policies which allow their customers to obtain refunds or store credits for previously purchased items that go on sale within a designated time period (e.g., 30 days) after the date of purchase. Generally, each customer must keep track of the purchased items and prices, as well as when the price of the purchased items has been reduced. When the previously purchased items go on sale at a later date, the customer must remember that the items were previously purchased at a higher price and bring back the sales receipt to the store to obtain the refund or credit. Typically, the customers are unable to keep track and/or remember the purchased items and the purchased price, and thus, the customers usually do not request refunds or credits for purchased items that went on sale, even though the customers are entitled to the refund or credit.

Therefore, there is a need for a method for tracking price reduction of a purchased item and notifying a customer of the price reduction.

### SUMMARY OF THE INVENTION

Embodiments of the present invention generally provide method and apparatus for tracking price reduction of a purchased item and notifying a customer of the price reduction. One embodiment provides a method for tracking a price reduction for an item purchased by a customer, comprising: receiving, by a central computer system, transaction data from a store computer system, the transaction data including an item identification number and an item purchase price; comparing an item sale price to the item purchase price; and if the item purchase price is higher than the item sale price, creating a notification file for the customer. The notification file may comprise an electronic mail and include one or more information selected from item sale price, item purchase price, purchase date, and store name.

Another embodiment provides a signal bearing medium, comprising a program which, when executed by a processor, performs a method for tracking a price reduction for an item purchased by a customer, the method comprising: receiving, by a central computer system, transaction data from a store computer system, the transaction data including an item identification number and an item purchase price; comparing an item sale price to the item purchase price; and if the item purchase price is higher than the item sale price, creating a notification file for the customer.

Another embodiment provides a system for tracking a price reduction for an item purchased by a customer, comprising: a central computer system having a processor, a memory and one or more storage devices for storing data connected to the processor, wherein the processor is configured to perform a method comprising: receiving, by a central computer system, transaction data from a store computer system, the transaction data including an item identification number and an item purchase price; comparing an item sale price to the item purchase price; and if the item purchase price is higher than the item sale price, creating a notification file for the customer.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic diagram illustrating one embodiment of a network environment 100 for generating price reduction notifications.

FIG. 2 illustrates one embodiment of a customer table 200 containing customer records.

FIG. 3 illustrates one embodiment of a customer transaction table 300 containing customer transaction records.

FIG. 4 illustrates one embodiment of a price reduction table 400 containing price reduction records.

FIG. 5 is a flow chart illustrating a method 500 for determining customers who have purchased an item which had a price reduction occurred within a specified period.

FIG. 6 illustrates one embodiment of a temporary table 600 containing search result records.

### DETAILED DESCRIPTION OF THE PREFERRED EMBODIMENT

Embodiments of the present invention generally provide method and apparatus for tracking price reduction of a purchased item and notifying a customer of the price reduction. One embodiment provides a method for tracking a price reduction for an item purchased by a customer, comprising: receiving, by a central computer system, transaction data from a store computer system, the transaction data including an item identification number and an item purchase price; comparing an item sale price to the item purchase price; and if the item purchase price is higher than the item sale price, creating a notification file for the customer. The notification file may comprise an electronic mail and include one or more information selected from item sale price, item purchase price, purchase date, and store name.

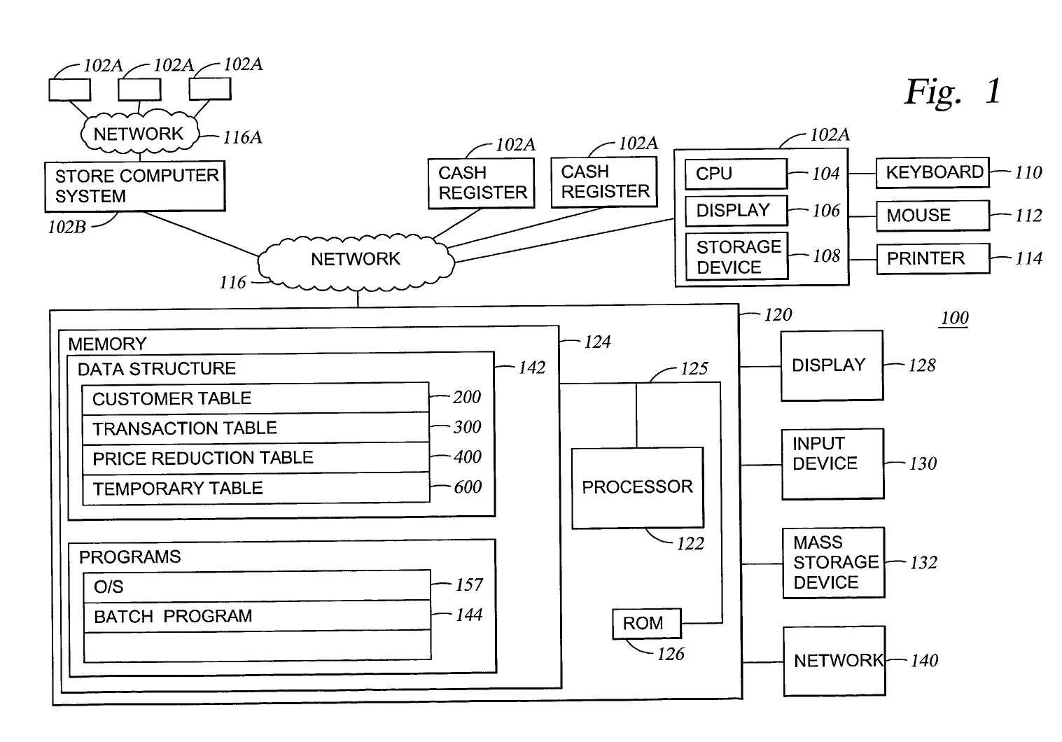

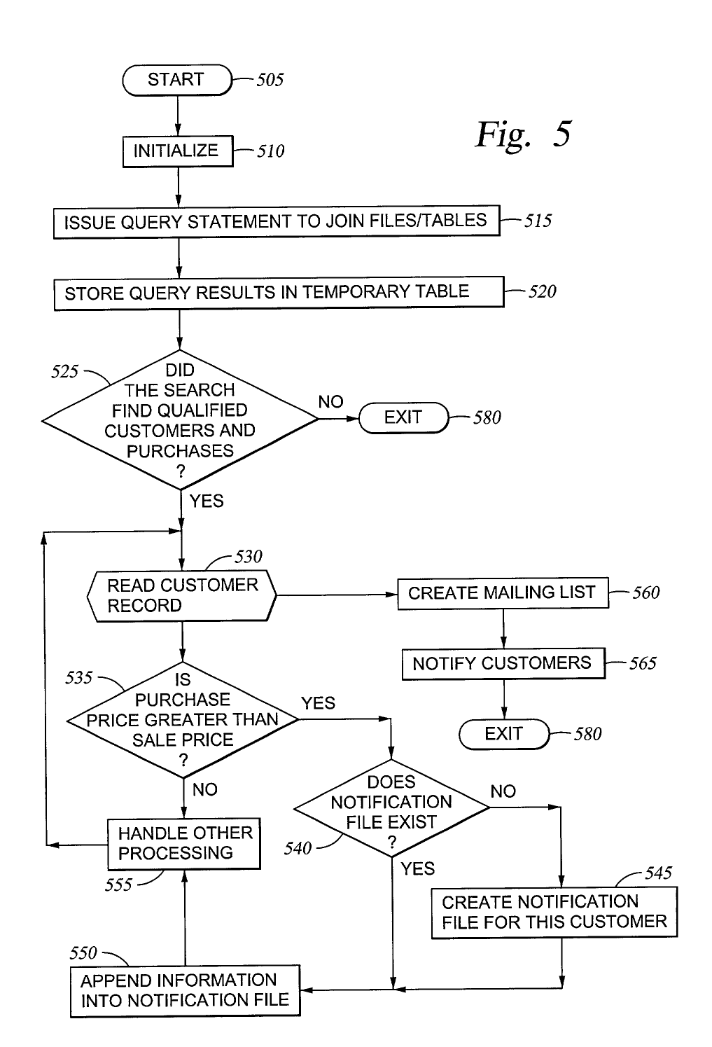

One embodiment of the invention is implemented as a program product for use with a computer system such as, for example, the network environment 100 shown in FIG. 1 and described below. The program(s) of the program product defines functions of the embodiments (including the methods described below with reference to FIG. 5) and can be contained on a variety of signal bearing media. Illustrative signal bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a schematic diagram illustrating one embodiment of a network environment 100 for generating price reduction notifications. The network environment 100 includes central control system 120 and a plurality of input systems 102. Illustratively, the input systems 102 may include a plurality of cash register computers 102a that are connected through the network 116 to the central control system 120. The input systems 102 may also include one or more store computer systems 102b connected through the network 116 to the central control system 120. Each store computer system 102b may include a store central system and a plurality of cash register computers 102a connected through a store network 116a to the store central system 102b.

Each cash register computer 102a may include a central processing unit (CPU) 104, a number of peripheral components, such as a computer display 106, a storage device 108, a printer 24, and various input devices (e.g., keyboard 110 and mouse 112). The network 116 may represent any type of local area network, wide area network, and public networks (e.g., the Internet). Moreover, any number of computers, networked systems and other devices may be networked through network 116 to connect to the central control system 120.

The central control system 120 may represent any type of computer, computer systems or other programmable electronic device, including a server computer, a client computer (e.g., input systems 102), a portable computer, a handheld computer, an embedded controller, a network of computers, etc. The central control system 120 illustratively includes at least one processor 122 coupled to memory 124 and read only memory (ROM) 126 via a bus 125. Processor 122 may represent one or more processors (e.g., microprocessors), and memory 124 may represent the random access memory (RAM) devices, comprising the main storage of the central control system 120, as well as any supplemental levels of memory, e.g., cache memories, nonvolatile or backup memories (e.g., programmable or flash memories), read only memories, etc. In addition, memory 124 may be considered to include memory storage physically located elsewhere in central control system 120, e.g., any cache memory in processor 122, as well as any storage capacity used as a virtual memory, e.g., as stored on a mass storage device 132 or on another computer coupled to the central control system 120 via network 116.

The central control system 120 also illustratively receives a number of inputs and outputs for communicating information externally. For interface with a user or operator, central control system 120 includes one or more user input devices 130 (e.g., a keyboard, a mouse, a trackball, a joystick, a touch pad, and/or a microphone, among others).

For additional storage, central control system 120 may also include one or more mass storage devices 132, e.g., a floppy or other removable disk drive, a hard disk, a direct access storage device (DASD), an optical drive (e.g., CD drive, a DVD drive, etc.) and/or a tape drive among others. Furthermore, central control system 120 may include and interface with one or more networks 140 (e.g., a LAN, a WAN, a wireless network, and/or the Internet, amongst others) to permit the communication of the information with other computers coupled to the network. It should be appreciated that the central control system 120 may include suitable analog and/or digital interfaces between processor 122 and each of the other components of the central control system 120 as known in the art.

Central control system 120 operates under the control of an operating system 157, and executes or otherwise relies upon various computer software applications, components, programs, objects, modules, data structures, etc. Illustratively, a plurality of data structures 142 include a customer table 200, a customer transaction table 300, a price reduction table 400 and a temporary table 600. One or more of the data structures 142 may be periodically updated with information from one or more of the input systems 102 (e.g., cash register computers and/or store computer systems). In particular, the price reduction table 400 may be periodically updated (e.g., weekly) with item sales information from the store computer systems. An illustrative program 144 may include a nightly batch program for determining customers who have purchased an item which had a price reduction occur within a specified period.

Moreover, various applications, components, programs, objects, modules, etc., may also execute on one or more processors in another computer coupled to the central control system 120 via a network 116, in a distributed or client-server computing environment, whereby the processing required to implement the functions of a computer program may be allocated to multiple computers over the network.

Those skilled in the art will recognize that the exemplary environments illustrated in FIG. 1 are not intended to limit the present invention. Indeed, those skilled in the art will recognize that other alternate hardware and/or software environments may be used without departing from the scope of the invention.

FIGS. 2-4 depict embodiments of the data structures 142. Each data structure is organized as a plurality of rows and columns. The columns designate a particular category of information while each row comprises a record in the data structure. For simplicity only one row/record of each data structure is shown. However, it is understood that the data structures may each comprise a plurality of rows/records.

FIG. 2 illustrates one embodiment of a customer table 200 containing customer records. Each customer record comprises a plurality of customer information entries, such as a customer account number entry 202, a customer name entry 204, a customer address entry 206, a customer phone number entry 208, customer social security number entry 210, customer email address entry 212, and entries for other information that the credit card company may have regarding the customer and/or account. In one embodiment, the customer information contained in the customer table 200 may be compiled from information previously provided by the customers in the credit card company's databases. The customer account number entry 202 contains unique credit card account numbers for each customer and may be used as the primary key (e.g., for identification or sorting of records) to the customer table. The customer name entry 204 contains each customer's name. The customer address entry 206 contains mailing or billing addresses for each customer. The customer phone number entry 208 contains home and/or business numbers for each customer. The customer social security number entry 210 contains each customer's social security number, which may also be used as the primary key to the customer table. The customer email address entry 212 contains one or more email addresses for each customer, which may be utilized for communicating a price reduction notification as discussed below.

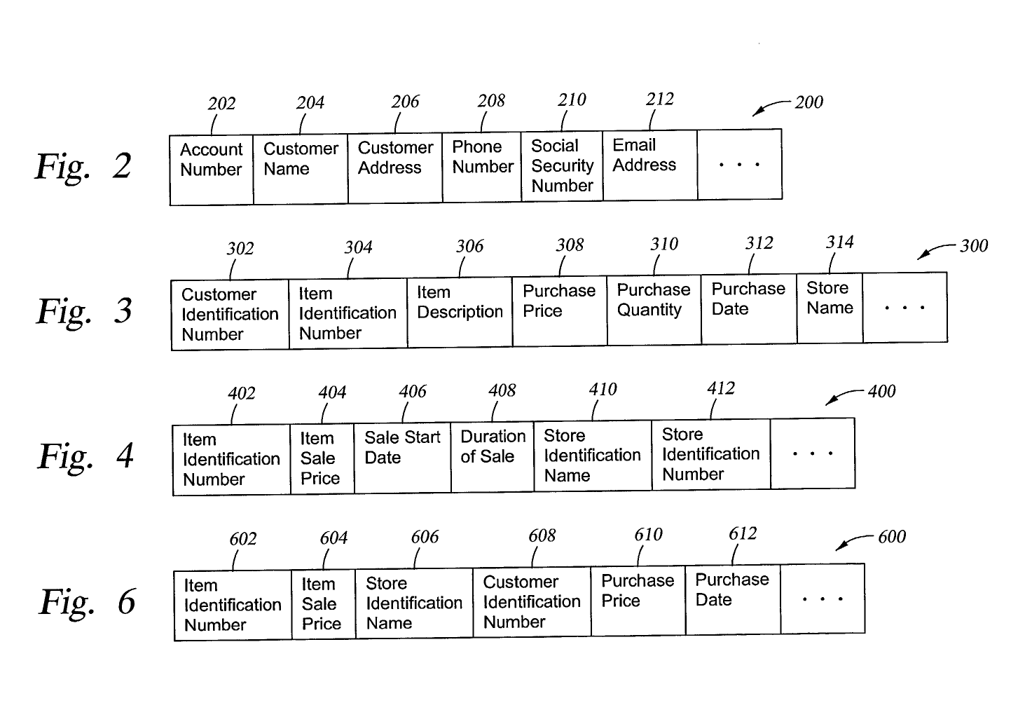

FIG. 3 illustrates one embodiment of a customer transaction table 300 containing customer transaction records. Each customer transaction record comprises a plurality of transaction information entries, such as a customer identification number entry 302, an item identification number entry 304, an item description entry 306, a purchase price entry 308, an item quantity entry 310, a purchase date entry 312, a store name entry 314, and entries for other transaction information that the credit card company may require regarding the transactions. In one embodiment, the information contained in the customer transaction table 300 may be provided by the cash register computers or the store central computer as each purchase transaction is reported to the credit card company. The customer identification number entry 302 contains a unique number for identifying the customer, such as the customer's credit card account number (e.g., entry 202) or the customer's social security number (e.g., entry 210). The item identification number entry 304 contains a unique product identification number, such as a Universal Product Code (UPC) number and an inventory number used by a particular store or a chain of stores. The item description entry 306 contains a brief description of the product. The purchase price entry 308 contains the unit price of the product as purchased by the customer. The item quantity entry 310 contains the quantity of the purchased product. The purchase date entry 312 contains the date of the purchase transaction. The store name entry 314 contains the name of the store where the purchase transaction occurred. Alternatively, a store identification number entry may be utilized to identify the store name and location from a database containing such information.

FIG. 4 illustrates one embodiment of a price reduction table 400 containing price reduction records. Each price reduction record comprises a plurality of price reduction information entries, such as an item identification number entry 402, an item sale price entry 404, an item sale start date entry 406, a duration of sale entry 408, a store identification name entry 410, a store identification number entry 412, and other information that may be provided by the store to the credit card company to indicate price reduction of an item. In one embodiment, the price reduction information entries are provided periodically (e.g., daily or weekly) by the store to the credit card company (e.g., from the store computer system to the credit card company computer system). The item identification number entry 402 contains a unique product identification number, such as a Universal Product Code (UPC) number and an inventory number used by a particular store or a chain of stores. The item sale price entry 404 contains the sale price or reduced price for the item. The item sale start date entry 406 contains the starting date of the sale or price reduction for the item. The duration of sale entry 408 contains the number of days for which the item will remain on sale. For a permanent price reduction of an item, a pre-designated maximum number may be utilized for the duration of sale entry 408. The store identification name entry 410 contains the name of the store having the sale or price reduction for the item. The store identification number entry 412 contains a unique number for identifying a particular store. A portion of the store identification number entries may be linked together to indicate chain stores.

FIG. 5 is a flow chart illustrating a method 500 for determining customers who have purchased an item which had a price reduction occur within a specified period. In one embodiment, the method 500 illustrates the execution of the periodically-performed (e.g., nightly) batch program 144 (e.g., by a credit card company). The method 500 begins at step 505 and proceeds to initialize the environment at step 510, including opening databases, initializing arrays, and performing other tasks in preparation for execution of the program. At step 515, the program issues a query statement to join customer table 200, customer transaction table 300 and price reduction table 400, which produces a list of all customers who have purchased one or more items that have had a price reduction within a designated period (e.g., in the last month or the previous 30 days). In one embodiment, the query statement further limits the list of customers to those who have purchased one or more items that have had a price reduction from the same store within the previous 30 days. At step 520, the list of customers produced by the query is put in a temporary table.

FIG. 6 illustrates one embodiment of a temporary table 600 containing search result records. Each search result record in the temporary table 600 comprises a plurality of entries, such as an item identification entry 602, an item sale price entry 604, a store identification name entry 606, a customer identification number entry 608, a purchase price entry 610, and a purchase date entry 612. The search result record in the temporary table 600 may further include other entries such as an item sale start date entry, a duration of sale entry, an purchased item quantity entry, and other entries from the tables illustrated in FIGS. 2-4.

At step 525, the program determines whether the search criteria (query statement in step 515) produced any customers who qualified the condition. The programs exits at step 580 if the search criteria produced no customer who qualified the condition. If the search criteria produced a list of customers who qualified the condition, the program proceeds to a loop defined from step 530 to step 555 to process each customer on the list to create and/or update the notification file for the customer.

At step 530, the program reads the next record (i.e., incrementally from the first record) in the temporary table. Then, at step 535, the item sale price is compared to the item purchase price to determine whether the purchase price is greater than the item sale price. If the purchase price is greater than the item sale price, then the program proceeds to determine whether a notification file already exists for this customer at step 540. If a notification file already exists for this customer, the information regarding the sale item, the item sale price, the purchase price of the item paid by the customer, the date of the purchase, and other information are added to the notification file at step 550. Optionally, the program may determine whether the same information already exists in the notification file and avoid repeating the same information in the notification file. Referring back to step 540, if a notification file does not already exists for this customer, a notification file is created for this customer at step 545, and then the information regarding the sale item, the item sale price, the purchase price of the item paid by the customer, the date of the purchase, and other information are added to the notification file at step 550.

The program then proceeds to handle other processing that may be needed by the credit card company at step 555, and then returns to step 530 to process/loop through the remaining records in the temporary table. For example, the program may check for duplicate information in the notification files and delete the duplicate information in step 555.

Referring back to step 535, if the purchase price is not greater than the item sale price, the program proceeds to handle other processing that may be needed by the credit card company at step 555, and then returns to step 530 to process/loop through the remaining records in the temporary table. After all records in the temporary table have been processed through the loop, the program proceeds to create a mailing list of customers from the notification files at step 560 and send the notification files (e.g., by e-mail) to the customers at step 565. In one embodiment, the notification files comprise electronic mails. Alternatively, the notification files may comprise other forms of electronic message or electronic messaging systems. The program exits at step 580, and may be repeated periodically (e.g., nightly).

After the batch processing has been completed and the notification files have been generated, the notification files may be stored in the credit card company databases where the customers may access as the customer's transaction history. Alternatively, after the notification files have been sent to the customers, the notification files may be deleted from the databases to free up storage space. Although the embodiments have been described as related to a credit card purchase and a credit card company computer system, other computer systems are contemplated by the invention for tracking price reductions for items purchased by customers and generating notification of the price reductions to the customers.

While the foregoing is directed to embodiments of the present invention, other and further embodiments of the invention may be devised without departing from the basic scope thereof, and the scope thereof is determined by the claims that follow.

What is claimed is:

1. A method for tracking a price reduction for an item purchased by a customer, comprising:
receiving, by a central computer system, transaction data from a store computer system, the transaction data including an item identification number and an item purchase price;
comparing an item sale price to the item purchase price; and
if the item purchase price is higher than the item sale price, creating a notification file for the customer.

2. The method of claim 1 wherein the transaction data further includes one or more information selected from a customer identification number, an item description, a quantity of item purchased, and a purchase date.

3. The method of claim 1, further comprising:
receiving, by the central computer system, price reduction data from the store computer system, the price reduction data including one or more price reduction information selected from an item identification number, an item sale price, an item sale start date, and an item sale duration.

4. The method of claim 3 wherein the central computer system periodically receives the price reduction data from the store computer system.

5. The method of claim 1 wherein the notification file includes one or more information selected from item sale price, item purchase price, purchase date, and store name.

6. The method of claim 1 wherein the notification file comprises an electronic mail.

7. The method of claim 6, further comprising sending the electronic mail to an electronic mail address of the customer.

8. The method of claim 1, further comprising:
checking information in the notification file for duplicate information; and
deleting duplicate information from the notification file.

9. The method of claim 1 wherein the central computer system is a credit card company computer system.

10. A signal bearing medium, comprising a program which, when executed by a processor, performs a method for tracking a price reduction for an item purchased by a customer, the method comprising:
receiving, by a central computer system, transaction data from a store computer system, the transaction data including an item identification number and an item purchase price;
comparing an item sale price to the item purchase price; and
if the item purchase price is higher than the item sale price, creating a notification file for the customer.

11. The signal bearing medium of claim 10 wherein the central computer system is a credit card company computer system.

12. The signal bearing medium of claim 10 wherein the transaction data further includes one or more information selected from a customer identification number, an item description, a quantity of item purchased, and a purchase date.

13. The signal bearing medium of claim 10, wherein the method further comprises receiving, by the central computer system, price reduction data from the store computer system, the price reduction data including one or more price reduction information selected from an item identification number, an item sale price, an item sale start date, and an item sale duration.

14. The signal bearing medium of claim 10 wherein the notification file includes one or more information selected from item sale price, item purchase price, purchase date, and store name.

15. The signal bearing medium of claim 10 wherein the notification file comprises an electronic mail.

16. The signal bearing medium of claim 15 wherein the method further comprises sending the electronic mail to an electronic mail address of the customer.

17. The signal bearing medium of claim 10 wherein the method further comprises:
checking information in the notification file for duplicate information; and
deleting duplicate information from the notification file.

18. A system for tracking a price reduction for an item purchased by a customer, comprising a central computer system having a processor, a memory and one or more storage devices for storing data connected to the processor, wherein the processor is configured to:
receive, by a central computer system, transaction data from a store computer system, the transaction data including an item identification number and an item purchase price;
compare an item sale price to the item purchase price; and
if the item purchase price is higher than the item sale price, create a notification file for the customer.

19. The system of claim 18 wherein the central computer system is a credit card company computer system.

20. The system of claim 18 wherein the transaction data further includes one or more information selected from a customer identification number, an item description, a quantity of item purchased, and a purchase date.

21. The system of claim 18 wherein the processor is further configured to receive, by the central computer system, price reduction data from the store computer system, the price reduction data including one or more price reduction information selected from an item identification number, an item sale price, an item sale start date, and an item sale duration.

22. The system of claim 21 wherein the central computer system periodically receives the price reduction data from the store computer system.

23. The system of claim 18 wherein the notification file includes one or more information selected from item sale price, item purchase price, purchase date, and store name.

24. The system of claim 18 wherein the notification file comprises an electronic mail.

25. The system of claim 24 wherein the processor is further configured to send the electronic mail to an electronic mail address of the customer.

26. The system of claim 18 wherein the processor is further configured to check and delete duplicate information from the notification file.
